(19) United States
(12) Patent Application Publication
(10) Pub. No.: US 2026/0284915 A1
(43) Pub. Date: Sep. 24, 2026

(54) SYSTEM FOR REMOVING MATERIAL FROM A MATERIAL ROLL AND USE OF SUCH A DEVICE

(71) Applicant: Core Link AB, Falkenberg (SE)

(72) Inventor: Christian WENNERBERG, Falkenberg (SE)

(21) Appl. No.: 19/541,997

(22) Filed: Feb. 17, 2026

(30) Foreign Application Priority Data
Mar. 20, 2025 (SE) 2550254-3

(51) Int. Cl. B26D 3/00; B26D 1/18

(52) U.S. Cl. CPC B26D 3/001; B26D 1/185; B26D 2210/11

(57) ABSTRACT

A system (1) for cutting material (2) on elongate tubular roll (3) is adapted to be arranged at the elongate tubular roll (3) having an axis (A). The system (1) comprises a rotary cutter (4) arranged on an axle (5) perpendicular to the axis (A) of the elongate tubular roll (3). The axle (5) is rotatably attached to a carrier (6) movably arranged in parallel to the axis (A) of the elongate tubular roll (3). The axle (5) has a coupling part (7), wherein the system (1) comprises a drive device (8) connected to the coupling part (7) of the axle (5), wherein the drive device (8) is arranged such that when the carrier (6) is moved along the axis (A) of the elongate tubular roll (3), the axle (5) is made to rotate with the rotary cutter (4) to cut the material (2) on the elongate tubular roll (3).

### TECHNICAL FIELD

The present invention is related to a system for removing material from a material roll. More specifically the present invention is related to a system for cutting material on elongate tubular roll. The system is adapted to be arranged at the elongate tubular roll having an axis, wherein the system comprises a rotary cutter arranged on an axle perpendicular to the axis of the elongate tubular roll. The axle is rotatably attached to a carrier movably arranged in parallel to the axis of the elongate tubular roll.

These types of systems are commonly utilized for slabbing rolls and removing residual material from material rolls. The material rolls typically consist of a core with material wound around it. The material itself can vary widely depending on the application and industry. For example, such material may include cellulose-based materials (such as paper, tissue, or nonwoven fabrics), plastic films, or metal foils, all of which are typically arranged in the form of a continuous sheet, commonly referred to as web material.

Devices designed for these purposes are often referred to as roll slabbers or slabbing devices. These systems play a crucial role in industries where it is necessary to reclaim or dispose of unwanted material efficiently. This includes applications such as removing damaged outer layers, reclaiming usable material from defective rolls, or eliminating residual material before recycling the core. In industrial settings, roll slabbing is essential for waste reduction, material recovery, and process optimization, ensuring that rolls can be repurposed or disposed of effectively while minimizing material loss.

### BACKGROUND

In the production of web materials, such as tissue, paper, and other sheet-based products, the material is typically wound onto a material roll, which is also sometimes referred to as a reel. These material rolls often consist of a central core, onto which the web material is systematically wound during manufacturing. The core provides structural support and facilitates further processing, transportation, and unwinding during subsequent manufacturing or conversion steps.

Material rolls used in industrial applications can be large and heavy, often requiring specialized machinery for handling, transport, and processing. These rolls can weigh hundreds of kilograms and may have diameters exceeding one meter, making manual handling impractical. Due to their size and weight, dedicated equipment is necessary for moving, storing, and processing these rolls efficiently.

In many cases, there arises a need to remove material from the roll. This can be required for various reasons, such as:
Eliminating residue material left on a roll after a production run.
Recovering and recycling material from defective or damaged rolls.
Reclaiming and reusing the core after the web material has been removed.
Preparing rolls for repurposing in secondary applications.

Efficient material removal is critical in industries that prioritize sustainability, waste reduction, and cost efficiency. By implementing automated systems for slabbing and material recovery, manufacturers can minimize material waste, enhance operational efficiency, and promote circular economy practices within their production processes.

There are numerous prior art solutions for removing material from industrial material rolls. One such solution is disclosed in U.S. Pat. No. 6,761,098, which describes an apparatus designed for efficiently removing material from a material roll. This apparatus features a rotating cutter mounted on a reciprocating carriage, which enables precise cutting of the material on the roll. Additionally, the apparatus incorporates a plough mechanism that parts the cut material as the carriage traverses the roll, facilitating efficient removal.

While existing solutions, such as the one disclosed in U.S. Pat. No. 6,761,098, provide effective means for material removal, certain applications—particularly those in industries where hygiene is a critical concern—require enhanced system solutions that address sanitary and contamination risks. In environments such as food processing, pharmaceuticals, and medical manufacturing, conventional material removal methods may introduce contaminants or fail to meet stringent cleanliness standards. Therefore, there is a need for an improved system that not only ensures efficient material removal but also integrates hygienic design principles, such as minimizing contamination, enabling easy cleaning, and using sanitary materials.

### SUMMARY

Hence, it is an object of the present invention to provide a system which takes hygiene more into account than prior art solutions or at least to provide an alternative system.

According to a first aspect of the present disclosure a system for cutting material on elongate tubular roll is provided. More specifically, cutting material from an elongate tubular roll comprising a core and material wound onto the core The system is adapted to be arranged at the elongate tubular roll having an axis. The system comprises a rotary cutter arranged on an axle perpendicular to the axis of the elongate tubular roll, wherein the axle is rotatably attached to a carrier movably arranged in parallel to the axis of the elongate tubular roll.

The axle has a coupling part, wherein the system comprises a drive device connected to the coupling part of the axle. The drive device is arranged such that when the carrier is moved along the axis of the elongate tubular roll, the axle is made to rotate with the rotary cutter to cut the material on the elongate tubular roll.

In previous designs, conventional motors are typically mounted in direct connection with the rotary cutter. This configuration presents a significant risk of contamination to the elongate tubular roll due to potential exposure to lubricants, metal shavings, dust, and other particulates generated during operation. Such contamination can compromise the quality and integrity of the roll, particularly in applications requiring high cleanliness standards, such as in food processing, pharmaceuticals, or precision manufacturing. Additionally, direct motor coupling may contribute to mechanical wear and reduce the overall efficiency and lifespan of the system.

Thus, in the solution presented by the present disclosure, the rotary cutter is driven indirectly by the movement of the carrier, which in turn causes the axle to rotate via the drive device. Unlike conventional systems where the motor is directly coupled to the rotary cutter, this approach ensures that the drive device remains fixed relative to the carrier, minimizing the risk of contamination from lubricants, metal shavings, dust, or other particulates that could compromise the integrity of the elongate tubular roll. By eliminating direct motor contact with the cutting mechanism, this design not only enhances cleanliness but also reduces mechanical wear, leading to improved durability and operational efficiency. Furthermore, by leveraging the movement of the carrier to induce rotation in the axle, the system achieves a more controlled and consistent cutting process, which is particularly beneficial in precision applications such as food processing, pharmaceuticals, and high-precision manufacturing. This innovative arrangement could ultimately extend the lifespan of both the cutting system and the materials being processed while ensuring compliance with stringent industry hygiene and quality standards.

According to a further aspect of the present disclosure, the system further comprises a frame with a holder for the elongate tubular roll, wherein the holder is arranged to rotate the elongate tubular roll around its axis, and wherein the carrier is movable in relation to the frame.

In other words, the system additionally comprises a frame equipped with a holder designed to secure and rotate the elongate tubular roll around its axis. This configuration ensures that the roll remains properly aligned during the cutting process, allowing for more accurate and consistent material removal. Furthermore, the carrier is designed to move independently in relation to the frame, providing greater flexibility and control over the cutting operation.

By incorporating a rotatable holder for the elongate tubular roll, this design allows for precise positioning and controlled rotation, which is particularly advantageous in applications requiring high accuracy, such as in the production of packaging materials, textiles, or industrial films. The ability to rotate the roll in coordination with the movement of the carrier enhances the overall precision of the system, reducing material waste and improving cutting efficiency. Additionally, this arrangement minimizes the need for manual adjustments, streamlining the cutting process and ensuring uniformity in the final product. Ultimately, the improved control and stability provided by this aspect of the disclosure contribute to a more reliable and high-performance cutting system.

The rotation of the holder enables the system to execute multiple precise cuts along the length of the elongate tubular roll, as required. This rotational capability provides enhanced flexibility in determining the exact locations where the cuts are made, allowing for customization based on specific processing needs. By adjusting the holder's position, the system ensures consistent and accurate cutting, accommodating different roll sizes and cutting patterns. Additionally, this functionality enhances efficiency and precision, reducing material waste and ensuring uniformity in the final processed sections.

According to a further aspect of the present disclosure, the carrier and the holder are movably arranged in relation to each other in a radial direction of the axis of an elongate tubular roll.

Hence, the cutting process is not only facilitated with maintained precision but also offers enhanced adaptability to accommodate elongate tubular rolls of varying diameters. By allowing relative movement between the carrier and the holder in the radial direction of the roll's axis, the system ensures that the rotary cutter can be precisely positioned regardless of the roll's size. This flexibility is particularly beneficial in industries where different roll diameters are processed, such as in paper manufacturing, textiles, and film production. Moreover, this adaptable design minimizes the need for manual recalibration or additional tooling, improving operational efficiency and reducing downtime. By automatically adjusting to different roll sizes, the system enhances both accuracy and productivity while maintaining a consistently high-quality cutting performance.

According to yet another aspect of the present disclosure, the drive device is one of a toothed belt, a belt, a drive chain, and a rack rail.

Thus, the drive device employed to facilitate the rotation of the axle and, consequently, the rotary cutter, is selected from a range of standard drive mechanisms, including a toothed belt, a belt, a drive chain, or a rack rail with a meshed spur gear. Each of these drive devices offers distinct advantages depending on the specific application requirements, such as precision, durability, load capacity, and maintenance needs.

A toothed belt provides highly accurate and slip-free motion transmission due to its interlocking teeth, making it ideal for applications requiring precise synchronization. It offers smooth operation with minimal maintenance and is well-suited for environments where cleanliness is a priority, as it does not require lubrication.

A standard belt operates on frictional engagement and is often used in applications where a simpler and quieter transmission system is preferred. While it may not offer the same level of precision as a toothed belt, it provides a cost-effective and efficient solution for many cutting operations, especially where slight variations in movement are acceptable.

A drive chain consists of interlinked metal components that mesh with sprockets to provide robust power transmission. Drive chains are highly durable and capable of handling heavy loads, making them ideal for industrial applications that demand high torque. However, they may require periodic lubrication and maintenance to ensure longevity and prevent contamination.

A rack rail with a meshed spur gear is a rigid and highly precise drive mechanism that converts rotary motion into linear motion with excellent positional accuracy. This system is particularly advantageous when a high degree of control over movement is required, making it a preferred choice in applications involving automated material processing or CNC-controlled cutting operations.

By integrating one of these standard drive devices, the present disclosure ensures versatility, allowing the system to be optimized based on operational needs. The selection of the appropriate drive mechanism depends on factors such as required precision, environmental conditions, load-bearing capacity, and maintenance considerations, ultimately contributing to a more efficient and reliable cutting process.

The carrier is according to an alternative aspect of the present disclosure an elongate beam being reciprocally movable in its longitudinal direction and when in use such that it is parallel to the axis of the elongate tubular roll.

For instance, the axle could be positioned near one end of the elongate beam, allowing the beam to extend and retract in a telescopic manner to facilitate controlled movement during the cutting process. This telescopic configuration enhances the system's adaptability by enabling precise positioning of the rotary cutter while minimizing the overall footprint of the apparatus. By employing a telescoping motion, the beam can extend to reach different sections of the elongate tubular roll and retract when not in use, optimizing space efficiency and reducing mechanical strain. Additionally, this design allows for smooth and continuous cutting operations, as the reciprocating motion of the beam ensures consistent engagement between the rotary cutter and the material being processed. This approach is particularly advantageous in applications requiring compact, yet highly flexible, cutting solutions while maintaining precision across varying roll sizes and working conditions.

According to yet another aspect of the present disclosure, the elongate beam mentioned above has a cover underneath the coupling part of the axle.

This design minimizes the risk of contaminants, such as dust, debris, metal shavings, or lubricant residues, from falling onto the elongate tubular roll during operation. By positioning a protective cover beneath the coupling part of the axle, any particles generated by the interaction between the coupling part and the drive device are effectively shielded from the roll surface. This is particularly critical in applications requiring high cleanliness standards, such as in food processing, pharmaceuticals, and precision manufacturing, where even minor contamination can compromise product quality. Additionally, the cover helps to protect the drive components from external contaminants, reducing wear and extending the operational lifespan of the system. By implementing this safeguard, the present disclosure enhances both the reliability of the cutting process and the overall cleanliness of the working environment, ensuring consistent, high-quality results.

According to a preferred aspect of the above-mentioned cover, the cover extends along the length of the elongate beam.

By covering the full length of the beam, this design ensures that no particles, such as dust, lubricant residues, metal shavings, or other debris, can fall onto the elongate tubular roll from any part of the drive mechanism, thereby maintaining a clean and uncontaminated cutting environment.

Additionally, a full-length cover helps shield critical drive components, such as the axle coupling part and the drive device, from external contaminants like airborne dust or process-related debris. This not only enhances the durability of the drive system but also reduces maintenance needs by preventing premature wear and mechanical issues.

Furthermore, the extended cover can contribute to operator safety by enclosing moving parts, minimizing the risk of accidental contact with rotating or reciprocating mechanisms. Depending on the application, the cover could be designed as a rigid enclosure, a flexible shield, or a retractable guard to accommodate different system requirements while maintaining ease of access for maintenance.

By incorporating a cover that spans the entire length of the elongate beam, both the longevity and reliability of the cutting system, ensuring precision, cleanliness, and operational efficiency in various industrial applications is further improved.

According to one aspect of the present disclosure, the elongate beam is displaceable in its longitudinal direction via a pneumatic cylinder.

Using a pneumatic cylinder to displace the elongate beam in its longitudinal direction offers several advantages in terms of precision, efficiency, and reliability.
Smooth and Controlled Motion—Pneumatic cylinders provide consistent and controlled displacement of the elongate beam, ensuring smooth operation during the cutting process. This minimizes vibrations and sudden movements that could otherwise affect cutting precision and material quality.
Adjustable Speed and Force—The speed and force of the pneumatic cylinder can be easily adjusted by regulating air pressure, allowing for fine-tuned control based on the material properties of the elongate tubular roll. This flexibility ensures optimal cutting performance across different roll types and sizes.
Clean and Contamination-Free Operation—Unlike hydraulic systems, pneumatic cylinders do not require oil-based fluids, reducing the risk of leaks and contamination. This is particularly beneficial in industries such as food processing, pharmaceuticals, and precision manufacturing, where maintaining a clean environment is essential.
Durability and Low Maintenance—Pneumatic systems are known for their reliability and low maintenance requirements. With fewer moving parts compared to electric or hydraulic actuators, they are less prone to mechanical failure, reducing downtime and maintenance costs.
High-Speed Operation—Pneumatic cylinders can achieve rapid actuation, making them ideal for applications requiring quick and repetitive displacement of the elongate beam. This improves overall process efficiency and productivity.
Compact and Lightweight Design—Pneumatic cylinders are generally more compact and lightweight than comparable hydraulic or electromechanical systems, making them easier to integrate into the cutting system without adding unnecessary bulk.
Explosion-Proof and Safe in Harsh Environments—Because pneumatic cylinders operate on compressed air rather than electrical components, they are inherently safer in hazardous environments, such as those with flammable materials or dust-prone conditions.

By utilizing a pneumatic cylinder for longitudinal displacement of the elongate beam, the present disclosure ensures a highly efficient, precise, and reliable cutting system that meets the demands of various industrial applications while maintaining a clean and low-maintenance operation.

According to a preferred aspect of the present disclosure, the drive device 8 is fixed in an axial direction relative to the carrier 6.

This design approach simplifies the overall construction of the system by reducing the number of moving components, thereby enhancing reliability and durability. By keeping the drive device fixed in the axial direction relative to the carrier, potential mechanical complexities associated with additional guiding or alignment mechanisms are eliminated. This not only results in a more compact and lightweight structure but also decreases the likelihood of mechanical wear and failure over time.

Furthermore, minimizing the number of moving parts translates to lower maintenance requirements and increased operational efficiency. With fewer components subject to continuous motion, there is reduced friction, less risk of misalignment, and minimal need for frequent adjustments or lubrication. This is particularly advantageous in industrial applications where long-term durability and low maintenance are critical factors.

Additionally, a fixed drive device enhances cutting precision, as it ensures stable and consistent power transmission to the axle, preventing variations in rotational speed or force that could compromise the quality of the cut. This stability is especially beneficial when working with materials that require high accuracy, such as packaging films, textiles, or precision-engineered components.

By adopting this fixed drive device configuration, the present disclosure provides an optimized, reliable, and efficient cutting system that maintains high performance while reducing complexity and operational costs.

Further features of, and advantages with, the present invention will become apparent when studying the appended claims and the following description. The skilled person realize that different features of the present invention may be combined to create embodiments other than those described in the following, without departing from the scope of the claims.

### BRIEF DESCRIPTION OF THE DRAWINGS

The above, as well as additional objects, features and advantages of the present invention, will be better understood through the following illustrative and non-limiting detailed description of exemplary embodiments of the present invention, wherein:

FIG. 1 is a schematic sideview of a system according to one embodiment of the present disclosure.

FIGS. 2 to 4 are three schematic views of a system according to a further embodiment of the present disclosure.

FIGS. 5 to 7 are three schematic views of a system according to yet another embodiment of the present disclosure.

### DETAILED DESCRIPTION OF EXAMPLE EMBODIMENTS OF THE INVENTION

Specific embodiments of the invention will now be described with reference to the accompanying drawings. However, it should be understood that the invention is not limited to the embodiments presented herein, as it may take various forms. These embodiments are provided to ensure a thorough and comprehensive disclosure, allowing those skilled in the art to fully understand the scope of the invention. The terminology used in the detailed description of the illustrated embodiments is for explanatory purposes only and should not be interpreted as limiting the invention. In the drawings, identical reference numbers denote corresponding elements for clarity and consistency.

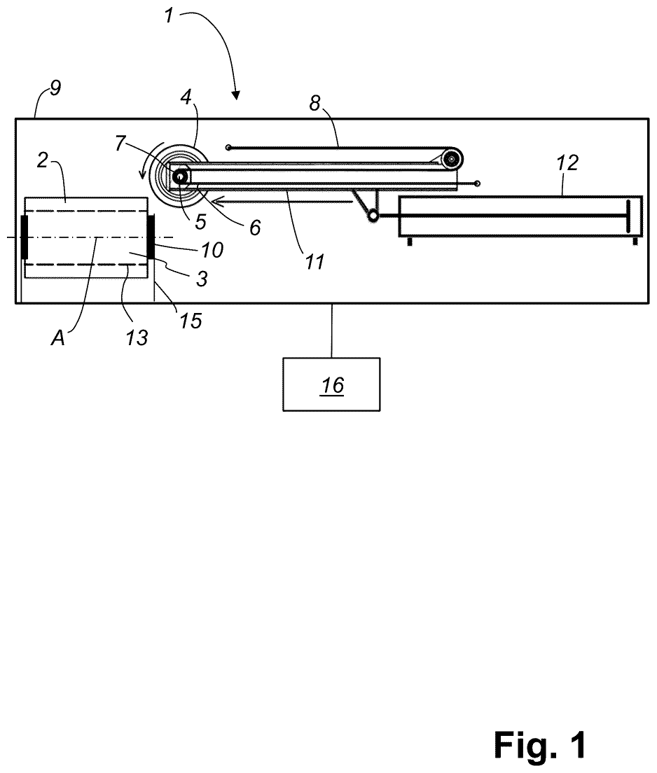

With reference to FIG. 1, a system 1 for cutting material 2 on an elongate tubular roll 3 is shown schematically. More specifically, a system 1 for cutting material 2 from an elongate tubular roll 3 comprising a core 13 and material 2 wound onto the core 13 The system 1 is positioned relative to the elongate tubular roll 3, which has an axis A. The system 1 comprises a rotary cutter 4 mounted on an axle 5, which is perpendicular to the axis A of the elongate tubular roll 3. The axle 5 is rotatably attached to a carrier 6, which is designed to move in parallel to the axis A of the elongate tubular roll 3.

The axle 5 includes a coupling part 7, which connects to a drive device 8. The drive device 8 is configured in such a way that, when the carrier 6 moves along the axis A of the elongate tubular roll 3, the axle 5 rotates, causing the rotary cutter 4 to cut the material 2 on the roll. This arrangement ensures synchronized cutting as the carrier moves along the roll.

As depicted schematically, the system 1 also includes a frame 9 equipped with a holder 10 for securely supporting the elongate tubular roll 3. The holder 10 is designed to rotate the elongate tubular roll 3 around its axis A, providing the necessary motion for the roll as the cutter engages with the material 2. Meanwhile, the carrier 6 remains movable relative to the frame 9, enabling precise positioning of the cutter.

Additionally, the carrier 6 and the holder 10 are arranged such that they can move relative to each other in the radial direction of the axis A of the elongate tubular roll 3. This feature allows for adjustments to accommodate different roll sizes and cutting requirements, offering enhanced flexibility and precision during operation.

In the embodiment shown, the drive device 8 is implemented using either a belt or a drive chain, both of which are commonly used for reliable motion transmission in mechanical systems. The carrier 6, in this case, is an elongate beam that moves reciprocally in its longitudinal direction. When in use, the carrier 6 is oriented such that it is parallel to the axis A of the elongate tubular roll 3, ensuring smooth, continuous cutting motion.

The elongate beam further includes a cover 11 beneath the coupling part 7 of the axle 5. This cover 11 serves to shield the coupling area, preventing contaminants such as dust, lubricant, or debris from falling onto the elongate tubular roll 3. Notably, the cover 11 extends along the full length of the elongate beam, offering protection across the entire operational area of the system.

Also depicted in FIG. 1 are actuators 15, which are responsible for moving the holders 10 up and down, providing precise control over the vertical positioning of the elongate tubular roll 3. This adjustment capability allows for the optimization of the cutting process, enabling the system to accommodate varying material thicknesses or changes in cutting requirements. The actuators 15 can be controlled to raise or lower the holders 10 in a smooth, controlled manner, ensuring that the cutting height can be adjusted quickly and accurately to maintain consistent performance.

In an alternative configuration, the carrier 6—along with the rotary cutter 4—could be designed to move up and down instead of the holders 10. This approach would allow the cutting mechanism itself to be adjusted vertically, directly influencing the depth and position of the cut on the elongate tubular roll 3. The ability to modify the cutting height in this manner would offer enhanced flexibility, allowing operators to fine-tune the cutting process for different material properties or cutting patterns.

This dual flexibility, either adjusting the holders 10 or the carrier 6 and rotary cutter 4, provides the system with the versatility needed to handle a variety of cutting scenarios, improving its adaptability to a broader range of applications. Whether adjusting the material's position or the cutter's position, both options offer advantages in terms of precision and customization of the cutting process, ensuring optimal results in both automated and manual settings.

By offering the ability to move either the holders or the cutter, the system is able to accommodate different material types, cutting depths, and roll sizes, providing a high level of versatility that ensures the cutting process is always tailored to meet specific operational needs. Additionally, these adjustments can improve operational efficiency by allowing the system to quickly adapt to changes in material specifications or production requirements, leading to reduced setup times and increased throughput.

The system 1 additionally includes a control unit 16, which is responsible for managing and coordinating the various components within the system 1. The control unit 16 is preferably equipped with an interface that allows users to both monitor and adjust system settings, as well as input relevant data. This interface may include a touchscreen display, physical buttons, or other input mechanisms designed for ease of use and efficient interaction. Moreover, the control unit 16 may facilitate communication between different subsystems, ensuring seamless operation and real-time adjustments based on user inputs or system requirements.

Finally, the elongate beam is displaced along its longitudinal direction via a pneumatic cylinder 12. The use of a pneumatic cylinder provides precise control over the movement of the beam, allowing for smooth and efficient adjustments as needed. The pneumatic system also offers the benefits of reduced mechanical complexity, low maintenance requirements, and the ability to adapt to different operational speeds and forces, enhancing the overall performance and flexibility of the cutting system.

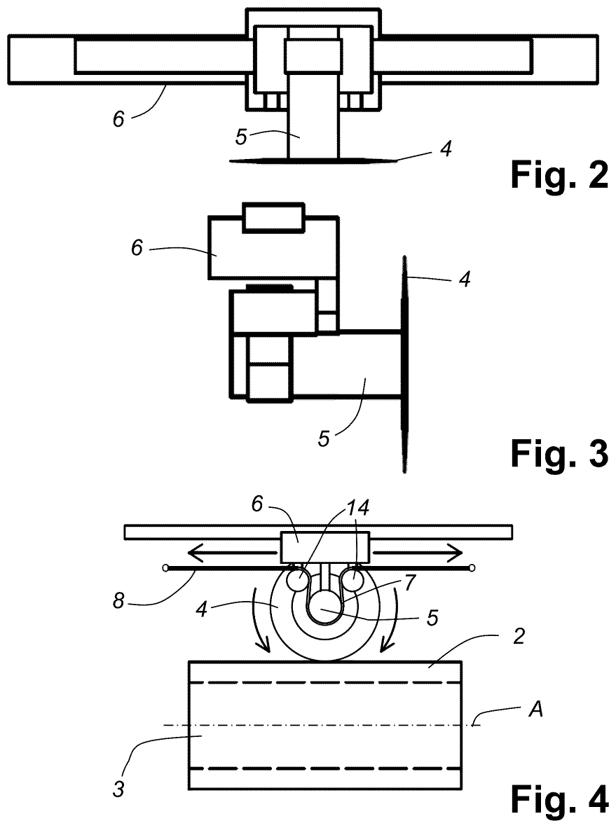

FIGS. 2 to 4 illustrate an embodiment of the present disclosure from various perspectives, providing a comprehensive view of the system's components and their arrangement. Specifically, FIG. 4 highlights the inclusion of two control wheels 14, which play a crucial role in the system's functionality. These control wheels 14 are strategically positioned to tension the belt 8, ensuring it is properly tightened around the coupling device 5.

The primary function of the control wheels 14 is to adjust the tension of the belt 8, which improves the contact area between the belt and the coupling device 5. By increasing the contact surface, the wheels help to enhance the grip between the two components. This results in a significant reduction in slippage, ensuring more efficient power transmission and consistent operation of the rotary cutter 4.

Furthermore, the ability to precisely control the tension on the belt 8 contributes to optimal system performance. When the belt is tightly secured, it minimizes the chances of loss of rotational force, thereby increasing the reliability and efficiency of the cutting process. This is especially important in applications requiring high precision, as maintaining consistent torque is critical to achieving accurate cuts.

In addition to improving performance, the control wheels 14 also offer maintenance advantages. The ability to adjust the tension of the belt 8 makes it easier to accommodate wear and tear over time, ensuring that the system can be easily recalibrated for continued efficiency. Additionally, the tensioning system reduces the likelihood of excessive wear on both the belt and the coupling device 5, further extending the lifespan of the components and minimizing downtime.

Thus, the integration of the control wheels 14 enhances the overall effectiveness of the drive system, providing both operational stability and long-term durability.

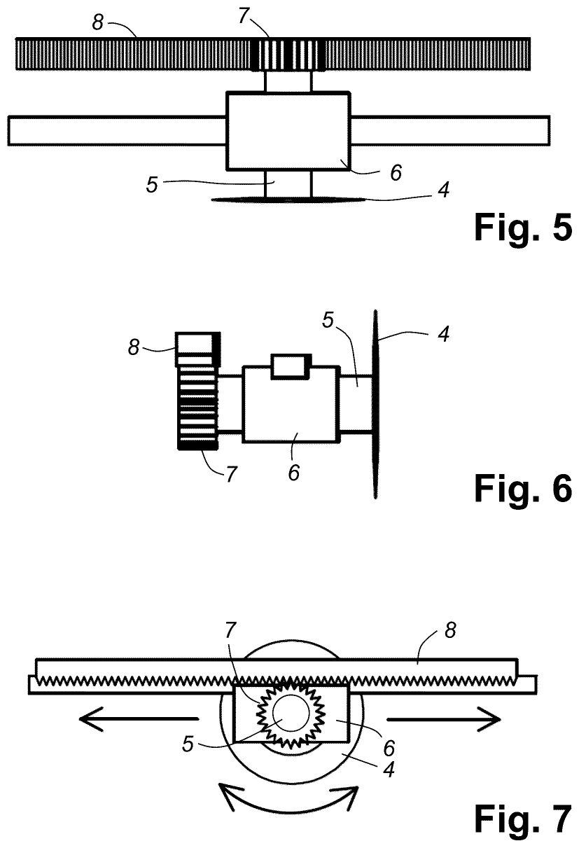

Turning to FIGS. 5 to 7, a further embodiment of the present disclosure is depicted from various perspectives, showcasing an alternative configuration of the system. In this embodiment, the drive device 8 is implemented as a rack rail, while the coupling part 7 is designed as a meshed spur gear.

This particular arrangement introduces a more robust and precise mechanism for driving the rotary cutter 4. The rack rail, a type of linear gear, engages with the spur gear, converting linear motion into rotational motion of the gear along and parallel to the axis A of the elongate tubular roll 3. This gear system allows for highly accurate control over the movement of the carrier 6, ensuring that the cutter is consistently aligned and positioned for precise cutting.

The meshed spur gear provides a direct connection to the coupling part 7, offering superior power transmission with minimal loss of torque. The interlocking teeth of the spur gear and the rack rail ensure smooth and reliable operation, even under heavy load conditions. This makes the system particularly well-suited for applications that require high precision and consistent performance, such as industrial manufacturing or material processing.

One of the primary advantages of this configuration is the ability to achieve precise and repeatable motion, thanks to the meshed spur gear's ability to maintain tight engagement with the rack rail. This reduces the likelihood of slippage or misalignment, which could otherwise compromise the quality of the cut or the operational efficiency of the system.

Additionally, the rack and spur gear arrangement offers enhanced durability compared to other drive mechanisms, as it distributes mechanical forces more evenly, reducing the risk of wear and tear on individual components. This contributes to a longer operational lifespan and lower maintenance requirements, making the system more cost-effective and reliable over time.

Overall, the integration of a rack rail and meshed spur gear in this embodiment provides a highly efficient, precise, and durable drive system that enhances the overall functionality of the cutting process. It combines the benefits of robust power transmission, precise linear motion, and long-term reliability, making it ideal for a range of industrial applications requiring both performance and longevity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

1. A system (1) for cutting material (2) on elongate tubular roll (3), the system (1) being adapted to be arranged at the elongate tubular roll (3) having an axis (A), the system (1) comprising a rotary cutter (4) arranged on an axle (5) perpendicular to the axis (A) of the elongate tubular roll (3), the axle (5) being rotatably attached to a carrier (6) movably arranged in parallel to the axis (A) of the elongate tubular roll (3),
wherein the axle (5) has a coupling part (7), and wherein the system (1) comprises a drive device (8) connected to the coupling part (7) of the axle (5), the drive device (8) being arranged such that when the carrier (6) is moved along the axis (A) of the elongate tubular roll (3), the axle (5) is made to rotate with the rotary cutter (4) to cut the material (2) on the elongate tubular roll (3).

2. The system (1) according to claim 1, wherein the system (1) further comprises a frame (9) with a holder (10) for the elongate tubular roll (3), wherein the holder (10) is arranged to rotate the elongate tubular roll (3) around its axis (A), and wherein the carrier (6) is movable in relation to the frame (9).

3. The system (1) according to claim 2, wherein the carrier (6) and the holder (10) are movably arranged in relation to each other in a radial direction of the axis (A) of an elongate tubular roll (3).

4. The system (1) according to claim 1, wherein the drive device (8) is one of a toothed belt, a belt, a drive chain, or a rack rail (meshed spur gear).

5. The system (1) according to claim 1, wherein the carrier (6) is an elongate beam being reciprocally movable in its longitudinal direction and when in use such that it is parallel to the axis (A) of the elongate tubular roll (3).

6. The system (1) according to claim 5, wherein the elongate beam has a cover (11) underneath the coupling part (7) of the axle (5).

7. The system (1) according to claim 6, wherein the cover (11) extends along the length of the elongate beam.

8. The system (1) according to claim 5, wherein the elongate beam is displaceable in its longitudinal direction via a pneumatic cylinder (12).

9. The system (1) according to claim 1, wherein the drive device (8) is fixed in an axial direction relative to the carrier (6).

10. Use of the system (1) according to claim 1 for cutting material (2) from an elongate tubular roll (3) comprising a core (13) and material (2) wound onto the core.
